(19) United States
(12) Patent Application Publication
(10) Pub. No.: US 2026/0371074 A1
(43) Pub. Date: Nov. 19, 2026

(54) A DELAY-DOPPLER BASED KEY GENERATION METHOD FOR SECURE WIRELESS COMMUNICATION

(71) Applicant: ISTANBUL MEDIPOL UNIVERSITESI TEKNOLOJI TRANSFER OFISI ANONIM SIRKETI, Beykoz, Istanbul (TR)

(72) Inventors: Mohammad Sohaib Jamal SOLAIJA, Beykoz, Istanbul (TR); Salah Eddine ZEGRAR, Beykoz, Istanbul (TR); Haji Muhammad Furqan Ahmed MADNI, Beykoz, Istanbul (TR); Huseyin ARSLAN, Beykoz, Istanbul (TR)

(21) Appl. No.: 19/133,972

(22) PCT Filed: Nov. 7, 2023
(86) PCT No.: PCT/TR2023/051262

§ 371 Date: May 29, 2025

(30) Foreign Application Priority Data
Dec. 28, 2002 (TR) 2022/021085
Dec. 2, 2022 (TR) 2022/018412

(51) Int. Cl. H04W 12/041; H04L 5/14

(52) U.S. Cl. CPC H04W 12/041; H04L 5/14

(57) ABSTRACT

A computer implemented Delay-Doppler domain-based key generation method for secure wireless communication between at least two devices.

### TECHNICAL FIELD

The invention is related to a computer implemented key generation method for secure wireless communication between at least two devices.

### PRIOR ART

Security of wireless links is becoming increasingly challenging with the deployment of heterogeneous networks. Due to the difference in capabilities of network entities, it is not possible to apply conventional cryptographic methods at all nodes.

Conventional cryptographic mechanisms used in wireless systems require some computational capabilities for the communicating nodes. Moreover, the encryption/decryption processes incur additional latency. Physical layer security (PLS) provides an alternative to do these using properties of the wireless channel. This includes key generation-based techniques where secret sequences are extracted from the shared propagation media. The key generation techniques rely on reciprocity of the channel features such as channel impulse response (CIR), channel frequency response (CFR) and received signal strength (RSS) which generally limits their applicability to time-division duplex (TDD) systems only. The frequency-division duplex (FDD) systems, on the other hand, does not experience reciprocal channel, rendering it difficult to generate shared keys in such systems.

Frequency-division duplex (FDD) systems have a clear advantage compared to time-division duplex (TDD) systems in terms of latency, but it comes at the cost of increased complexity in terms of channel estimation. Specifically, TDD systems leverage the reciprocity of the channel in uplink (UL) and downlink (DL) so that channel estimation overhead is reduced. However, this is only valid as long for channels with long (so that both UL and DL transmissions are carried out within this duration) coherence time.

FDD systems, however, do not experience reciprocal channel response. Therefore, in order to generate shared keys, they rely either on the combined UL and DL channels (which requires the same coherence time as TDD systems) or on parameters that are observed similarly at both communicating nodes. Examples of the latter include using delay and angle between the nodes to generate identical keys. Delay, while reciprocal, requires a large bandwidth to provide sufficient resolution while using angle necessitates the presence of multiple antennas at the communicating nodes.

There are a handful of works proposed for PLS of FDD systems using wireless channel properties. Most of these works involve estimation of the combined (uplink and downlink) channel using some feedback between the communicating nodes such as pilot loopback [1], combined CFR [2] and precoding matrix indicator (PMI) feedback [3].

An alternative is to use frequency-invariant channel parameters such as delay [4] or angle [5]. The former considers a device to-device (D2D) scenario where the time-varying distance (or propagation Delay) is used for key generation.

Angle of arrival (AoA) method in both elevation and azimuth dimensions is used to generate key [6]. The angle-based approach [6] is extended to an unmanned aerial vehicle (UAV) multiple-input multiple-output (MIMO) system, where the three-dimensional spatial angle between the legitimate nodes is used to generate the key. The eigenvalue reciprocity of the channel's covariance matrix [7] is also used, while a reciprocal channel [8] is constructed, which is then used to generate keys.

Amongst the aforementioned works, the combined channel-based approaches suffer from extra latency incurred due to the feedback process. On the other hand, the angle-based methods require a high number of antennas at the communicating nodes. Moreover, the covariance matrix-based technique offers low key generation rate (KGR) [9].

The current invention leverages the ability of orthogonal time frequency space (OTFS) and the underlying symplectic Fourier transform to convert a fast-fading wireless channel (in time-frequency domain) to a slow-varying one (in the delay-Doppler domain). Recently, the secrecy performance of OTFS-based transmissions has been studied for uplink satellite [10] and unicast services [11]. The former considers an eavesdropping satellite and a cooperative UAV jammer, while the latter analyzes the impact of the eavesdropper's mobility on secrecy. A channel-based pre-rotation is proposed [12] which leads to constellation distortion at the eavesdropper. Channel-dependent seed is employed in [13] to generate a Gosudarstvennyi standard-based sequence which is then used to perturb the OTFS modulation and secure the transmission.

As a result, all of the problem mentioned above has made it necessary to provide a novelty in the related field.

### OBJECTS OF THE INVENTION

The main object of the present invention is to establish a secure key generation method for secure wireless communication between at least two devices in FDD and TDD systems, especially in high-mobility scenarios, to mitigate the different security threats such as eavesdropping, jamming, and spoofing.

Another objection of the invention is providing security key generation method that does not require high number of antennas at the devices/communicating nodes at FDD and TDD systems.

### BRIEF DESCRIPTION OF THE INVENTION

In present invention, a secure key generation method is disclosed. In this method, the security keys are generated based on Delay-Doppler domain. More specifically, the keys are generated based on indices of Delay and Doppler bins and quantized fractional Delay and Doppler values.

### DESCRIPTION OF THE FIGURES OF THE INVENTION

The figures and related descriptions necessary for the subject matter of the invention to be understood better are given below.

FIG. 1. Schematic view of the devices communicates with each other.

FIG. 2. Flowchart illustrates starting steps of the invention.

FIG. 2a. Flowchart illustrates steps of the invention in TDD systems.

FIG. 2b. Flowchart illustrates steps of the invention in FDD systems.

FIG. 2c. Flowchart illustrates final steps of the invention.

FIG. 3. Schematic view of a system configured to carry out method of the invention.

### REFERENCE NUMBERS

The parts and components are given in the figures are referenced for the subject matter of the invention to be understood better.
10a. Device A
10b. Device B
A. Antenna
PU. Processing Unit
WC. Wireless channel
I. Illegitimate user

### DETAILED DESCRIPTION OF THE INVENTION

The invention is related to a computer implemented a key generation method for secure wireless communication between at least two devices and a communication method uses said security key, a system carries out said key generation method or communication method and a program comprising instructions which causes a computer, e.g. said system, execute said methods.

The mentioned devices are configured to communicate each other. The devices of the invention are any devices which is capable of wireless communication. The devices may be communication nodes, base stations, mobile devices, (e.g smartphone, laptop etc.) or stationary devices.

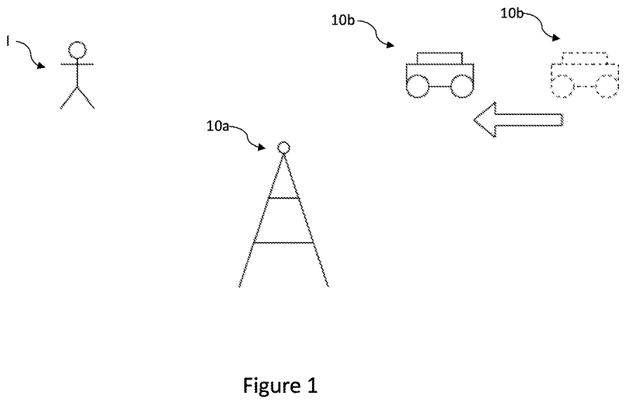

Two devices are illustrated as a device A (10a) and a device B (10b) in FIG. 1. The device A (10a) is shown as a base station and the device B (10b) is shown as a device positioned in a moving vehicle that moves in direction of the arrow. The vehicle shown with dotted line represent prior position of the vehicle. Also, illegitimate user (I) is shown in FIG. 1 and the illegitimate user (I) is a person or a system that causes security threats such as eavesdropping, jamming, and spoofing.

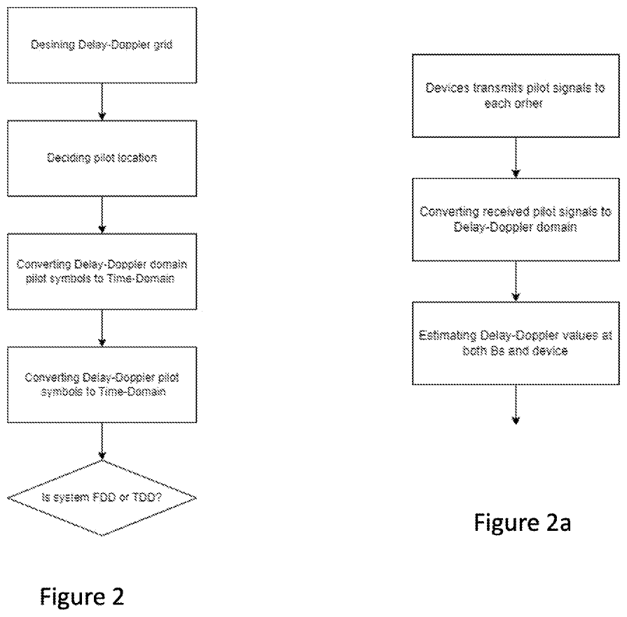

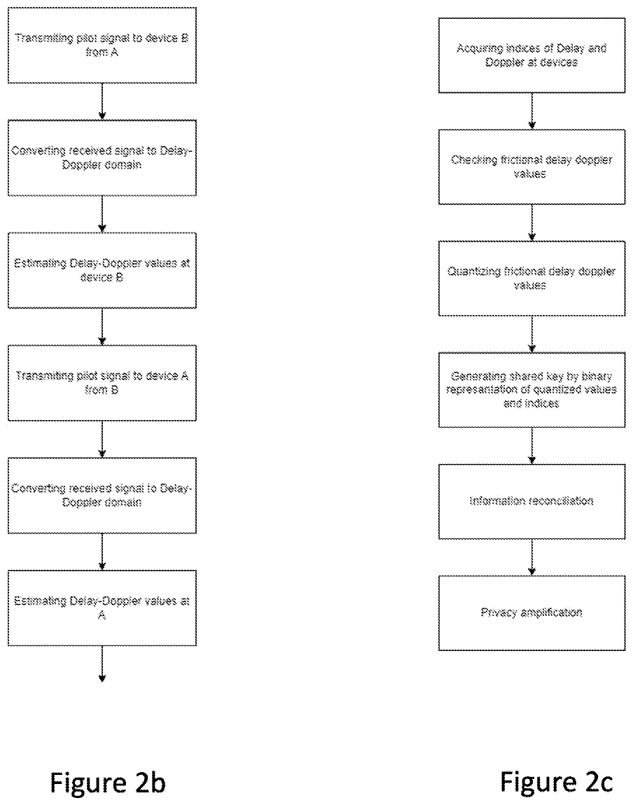

Referring to FIG. 2; First, Delay-Doppler grid is designed, and location of the pilot symbol is decided in said grid. Location of the pilot signal on the grid is known by both device A (10a) and device B (10b).

In a preferred embodiment, dimensions of the Delay-Doppler grid in both directions are calculated in accordance with at least one of the available bandwidths, number of available subcarriers, subcarrier spacing and transmission duration, preferably accordance with all.

The pilot signals are in Delay-Doppler domain in first stage of the method. Said signal is converted to time-domain for transmitting between device A (10a) and the device B (10b). In one embodiment, the conversion is carried out using inverse symplectic Fourier transform (ISFT) followed by Heisenberg transform.

The time-domain pilot signals are converted at the device A (10a) and the device B (10b) to Delay-Doppler domain again and Delay and Doppler values are obtained from said signals at both the device A (10a) and the device B (10b). Preferably, channel estimation framework method or framework is used for obtaining Delay and Doppler values. Preferably, the conversion is carried out by using a Wigner transform followed by symplectic Fourier transform (SFT).

Referring to FIG. 2c; After that indices of the Delay and Doppler bins for the shared wireless channels (WC) are acquired and fractional Delay and Doppler values are obtained by calculation or checking the system wherein indices are first part of the shared secret. After that, these fractional Delay and Doppler values are quantized wherein quantized values are second part of the shared secret. These values are used to generate shared security key.

To generate shared security key, the indices of Delay and Doppler bins and quantized fractional Delay and Doppler values are converted to a binary representation. For the integer delay and Doppler indices the decimal representation (base 10) is directly converted to binary scale (base 2). For the fractional parts of delay and Doppler shifts, the value is first converted divided by a quantization interval and the resultant is converted to a binary number similar to the integer parts. It is also possible to directly divide the complete (integer and fractional) delay and Doppler values by the quantization intervals and convert to binary representation.

A security key generation method for secure wireless communication between at least two devices comprising steps of designing a Delay-Doppler grid and deciding location of a pilot symbol, converting the Delay-Doppler pilot signals to time-domain on both devices, transmitting time-domain pilot signals to each other by the devices and converting pilot signals back to Delay-Doppler domain by the devices, acquiring Delay-Doppler values at both devices, acquiring indices of the Delay-Doppler values at both devices, acquiring and quantizing fractional Delay-Doppler values at both devices.

As can be seen in FIG. 2, there is a determination phase in this point which determines if the system is frequency division duplexing (FDD) or time-division duplex system (TDD). However, this determination step is optional. The method may be configured to only work with is frequency division duplexing or time-division duplex systems. For both frequency division duplexing (FDD) or time-division duplex system (TDD), the method is carried out same steps however order of steps can be different.

Referring to FIG. 2a; If the system determined as frequency-division duplex system (FDD), both devices (device A (10a) and device B (10b)) transmits the converted pilot signals to each other is carried out, simultaneously. After that, each of device A (10a) and device B (10b) converts signals to Delay-Doppler domain and obtains Delay and Doppler values from said signals.

Referring to FIG. 2b; If the system determined as time-division duplex system (TDD), the device A (10a) transmits the pilot signal converted to the device B (10b). The device B (10b) converts received signal to Delay-Doppler domain and obtains Delay and Doppler values from said signals. After that, the device B (10b) transmits the pilot signal converted to time-domain to the device A (10a). The device A (10a) converts back signal to Delay-Doppler domain to obtains Delay and Doppler values from said signals.

Referring to FIGS. 2a and 2b; for both time-division duplex system (TDD) and frequency-division duplex system (FDD), the pilot signals are transmitted between the devices and received signals are converted to Delay-Doppler domain to obtains Delay and Doppler values from said signals. Only difference here is transmission's order. Transmission is carried out between devices are simultaneous in time-division duplex systems however same transmission is carried out in order in frequency-division duplex systems.

For both time-division duplex system (TDD) and frequency-division duplex system (FDD), remaining steps are same above-mentioned key generation steps.

In preferred embodiment, an information reconciliation is carried out after above steps. This step is used to remove the key mismatch. In present invention, it is primarily used to take care of the Doppler shifts for both nodes particularly for FDD scenario where the Doppler is not reciprocal but related to the specific carrier frequency of the uplink/downlink transmissions.

In preferred embodiment, a privacy amplification is carried out after above steps. This step is used to enhance randomness of the generated key

Said method executed by a computer or below-mentioned system. The program comprises instructions for executing method on said computer or below-mentioned system. The program may be stored on a computer readable medium.

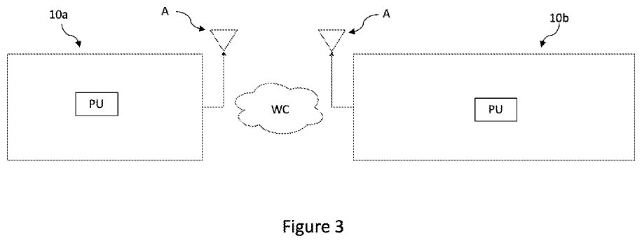

Referring to FIG. 3; a system is configured to carry out same above-mentioned method. The system comprises at least two devices (device A (10a) and device B (10b)) and both devices comprise at least one antenna (A) for communicate each other on a wireless channel (WC).

Both devices comprise at least one processing unit (PU) for carrying out steps of same above-mentioned method.

In preferred embodiment processing units (PU) are configured to perform specific steps of the method of the present invention. For example, the device A (10a) comprises processing unit (PU) configured to design delay-Doppler grid and pilot assignment and transform a delay-Doppler to time domain signal. The device B (10b) comprises processing unit (PU) configured to transform time-domain to delay-Doppler domain and estimate delay and Doppler value and index and quantize the estimated delay/Doppler values. Alternatively, one specific processing unit (PU) can be used for each function separately.

In an alternative embodiment, both devices comprise processing units (PU) configured to carry all steps and functions. Preferably, processing units (PU) of both devices are identical.

### REFERENCES

1. S. J. Goldberg, Y. C. Shah, and A. Reznik, “Method and apparatus for performing JRNSO in FDD, TDD and MIMO communications,” Mar. 19, 2013, U.S. Pat. No. 8,401,196.
2. X. Wu et al., “A secret key generation method based on CSI in OFDMFDD system,” in Globecom Workshops (GC Wkshps). IEEE, 2013, pp. 1297-1302.
3. H. Taha and E. Alsusa, “Secret key exchange using private random precoding in MIMO FDD and TDD systems,” IEEE Trans. Veh. Technol., vol. 66, no. 6, pp. 4823-4833, 2016.
4. O. Gungor, F. Chen, and C. E. Koksal, “Secret key generation from mobility,” in Globecom Workshops (GC Wkshps). IEEE, 2011, pp. 874-878.
5. Badawy et al., “Secret key generation based on AoA estimation for low SNR conditions,” in 81st Veh. Technol. Conf. (VTC Spring). IEEE, 2015, pp. 1-7.
6. K. Lin et al., “Secret key generation based on 3D spatial angles for UAV communications,” in Wireless Commun. Netw. Conf. (WCNC). IEEE, 2021, pp. 1-6.
7. B. Liu, A. Hu, and G. Li, “Secret key generation scheme based on the channel covariance matrix eigenvalues in FDD systems,” IEEE Commun. Lett., vol. 23, no. 9, pp. 1493-1496, 2019.
8. G. Li et al., “Constructing reciprocal channel coefficients for secret key generation in FDD systems,” IEEE Commun. Lett., vol. 22, no. 12, pp. 2487-2490, 2018.
9. J. Zhang et al., “A new frontier for IoT security emerging from three decades of key generation relying on wireless channels,” IEEE Access, vol. 8, pp. 138 406-138 446, 2020.
10. J. Hu et al., “Secrecy analysis for orthogonal time frequency space scheme based uplink LEO satellite communication,” IEEE Wireless Commun. Lett., vol. 10, no. 8, pp. 1623-1627, 2021.
11. Z. Tie et al., “Security performance analysis for an OTFS-based joint unicast-multicast streaming system,” IEEE Trans. Commun., vol. 70, no. 10, pp. 6764-6777, 2022.
12. J. Sun, Z. Wang, and Q. Huang, “Secure precoded orthogonal time frequency space modulation,” in 13th Int. Conf. Wireless Commun. Signal Process. (WCSP). IEEE, 2021, pp. 1-5.
13. W. Liang et al., “Underlying security transmission design for orthogonal time frequency space (OTFS) modulation,” Sensors, vol. 22, no. 20, p. 7919, 2022.

1. A computer implemented key generation method for secure wireless communication between at least two devices, the method comprising:
designing a Delay-Doppler grid and deciding location of a pilot symbol;
converting the Delay-Doppler pilot signals to time-domain on both devices;
transmitting time-domain pilot signals to each other by the devices and converting pilot signals back to Delay-Doppler domain by the devices;
acquiring Delay-Doppler values at both devices;
acquiring indices of the Delay-Doppler values at both devices;
acquiring and quantizing fractional Delay-Doppler values at both devices; and
converting the indices and quantized fractional Delay and Doppler values to a binary representation to be used as a security key.

2. A method according to claim 1, further comprising the step of determining if the system is frequency division duplexing or time-division duplex system.

3. A method according to claim 1, wherein transmitting the converted pilot signals to each other is carried out; simultaneously.

4. A method according to claim 1, comprising firstly transmitting the converted pilot signal to one of the devices from other one of the devices and the acquiring Delay-Doppler values at receiving device and after that transmitting pilot signal to transmitting device and acquiring the Delay-Doppler values at the transmitting device.

5. A method according to claim 1, comprising acquiring indices of the Delay-Doppler values by a channel estimation framework method or framework.

6. A method according to claim 1, wherein the dimension of the grid in both directions are calculated in accordance with at least one of available bandwidth, number of available subcarriers, subcarrier spacing and transmission duration.

7. A method according to claim 1, wherein conversion of the Delay-Doppler domain to time-domain is carried out by inverse symplectic Fourier transform followed by Heisenberg transform.

8. A method according to claim 1, wherein conversion of the time-domain to Delay-Doppler domain is carried out by Wigner transform followed by symplectic Fourier transform.

9. A method according to claim 1, further comprising the step of applying information reconciliation to remove the key mismatch.

10. A method according to claim 1, further comprising step of applying privacy amplification to enhance randomness of the generated key.

11. A system comprising means for carrying out the steps of the method of claim 1.

12. A computer program comprising instructions which, when the program is executed by a computer, cause the computer to carry out the steps of the method of claim 1.

13. A computer-readable medium having stored thereon the computer program of claim 12.
